(19) United States
(12) Patent Application Publication
(10) Pub. No.: US 2020/0318428 A1
(43) Pub. Date: Oct. 8, 2020

(54) BOTTOM RAIL FOR USE WITH AN ARCHITECTURAL-STRUCTURE COVERING

(71) Applicant: Hunter Douglas, Inc., Pearl River, NY (US)

(72) Inventors: Nickolas C. Buccola, JR., Gastonia, NC (US); Michael S. Goldberg, Stanley, NC (US); Thanh Vu, Pearl River, NY (US)

(73) Assignee: Hunter Douglas, Inc., Pearl River, NY (US)

(21) Appl. No.: 16/829,555

(22) Filed: Mar. 25, 2020

Related U.S. Application Data
(60) Provisional application No. 62/827,948, filed on Apr. 2, 2019.

(51) Int. Cl. E06B 9/46

(52) U.S. Cl. CPC E06B 9/46

(57) ABSTRACT

A bottom rail for a covering of an architectural-structure covering is disclosed. In one example of an embodiment, the bottom rail includes a first or front member, and a second or rear member. The first and second members are arranged and configured to be coupled to each other with a bottom portion of a covering positioned in between the first and second members. Thus arranged, the first member is coupled to the second member, and the covering is securely coupled to the bottom rail. In addition, and/or alternatively, the covering may be received within the bottom rail along a tortuous pathway. In addition, and/or alternatively, the bottom rail may include a front profile or surface that substantially corresponds to a front profile of battens extending across a width of the covering. Moreover, the bottom rail may enclose the lowermost batten so that consistent spacing of the battens is maintained.

### CROSS-REFERENCE TO RELATED APPLICATIONS

This is a non-provisional of, and claims the benefit of the filing date of, pending U.S. provisional patent application No. 62/827,948, filed Apr. 2, 2019, entitled “Bottom Rail for use with an Architectural-Structure Covering,” which application is incorporated by reference herein in its entirety.

### FIELD OF THE DISCLOSURE

The present disclosure relates generally to the field of architectural-structure coverings, and relates more particularly to an improved bottom rail for use with an architectural-structure covering.

### BACKGROUND

Architectural-structure coverings may selectively cover an architectural structure such as, for example, a window, a doorway, a skylight, a hallway, an archway, a portion of a wall, etc. Generally speaking, architectural-structure coverings may include a covering that can be extended and retracted, for example, vertically extendable or retractable (e.g., capable of being lowered or raised, respectively, in a vertical direction) between an extended position and a retracted position for obscuring and exposing the underlying architectural structure.

The architectural-structure covering may further include a bottom rail attached to a bottom portion of the covering. The bottom rail may be an elongate member that is coupled to or mounted (such terms may be used interchangeable herein without the intent to limit) to a bottom portion of the covering. For example, the elongated member may be a rigid elongated member. Generally speaking, the bottom rail provides a user a convenient location or “touchpoint” at which the user may engage the covering to raise (retract) or lower (extend) the covering, respectively. The bottom rail may also be provided to add weight to the bottom portion of the covering to encourage the covering to drop under a gravitational force during extension. End caps may be disposed on opposing longitudinal ends of the bottom rail. In some embodiments, the end caps may be coupled to the ends of the bottom rail using suitable mechanical fasteners.

The weight of the bottom rail may be typically transferred to the covering. Depending on the type of covering being utilized, the weight of the bottom rail may cause a bottom portion of the covering to be positioned, such as shaped, differently from other portions of the covering that are positioned more distally from the bottom rail, which may adversely impact the aesthetic and/or functional characteristics of the covering.

It is with respect to these and other considerations that the present improvements may be useful.

### SUMMARY

This Summary is provided to introduce in a simplified form, a selection of concepts that are further described below in the Detailed Description. This Summary is not intended to identify key features or essential features of the claimed subject matter, nor is it intended as an aid in determining the scope of the claimed subject matter.

Disclosed herein is an improved bottom rail for a covering of an architectural-structure covering. As will be described herein, the improved bottom rail contains a number of separate and independent aspects or features that may be used in combination with each other, or separately. In use, an improved bottom rail formed in accordance with certain principle of the present disclosure is coupled to a covering of an architectural-structure covering so that the covering is properly position in the extended position while preventing or minimizing a bottom portion of the covering from having an undesired aesthetic finish. In one example of an embodiment, the covering may be in the form of a roller shade including a plurality of vertically spaced slats or battens extending horizontally across the width of the covering.

In accordance with one separate and distinct aspect, the bottom rail may be a multi-piece bottom rail including a first or front member, and a second or rear member. The first and second members are arranged and configured to be coupled to each other. In one example of an embodiment, the first member is arranged and configured to couple to the second member with a bottom portion of a covering positioned in between the first and second members. Thus arranged, the first member is coupled to the second member, and the covering is securely coupled to the bottom rail.

In one example of an embodiment, a bottom rail arranged and configured to couple to a bottom portion of a covering in an architectural-structure covering is disclosed. The bottom rail comprises a front member and a rear member arranged and configured to couple to said front member, said front and rear members defining a channel when said rear member is coupled to said front member, wherein said channel is arranged and configured to receive a portion of the covering therethrough and said front and rear members are arranged and configured to couple to each other with the bottom portion of the covering extending at least partially with said channel.

In one example of an embodiment, the bottom rail may also include first and second lateral end caps arranged and configured to couple to either end of the bottom rail. The end caps may each include retention members arranged and configured to couple to the first and second members thus assisting with securely coupling the first and second members to each other.

In accordance with another separate and distinct aspect, that may or may not be used with the multi-piece bottom rail, the covering is arranged and configured to be received within the bottom rail along a tortuous pathway. That is, in one example of an embodiment, the bottom portion of the covering is coupled to the bottom rail via a tortuous pathway. Thus arranged, the covering is firmly secured to the bottom rail, thus preventing, or at least reducing, the likelihood that the bottom rail may be become decoupled from the covering during use. In one example of an embodiment, the tortuous pathway of the covering skews (e.g., rotates) the bottom rail such that the bottom rail lies in a substantially vertically oriented position.

In one example of an embodiment, an architectural-structure covering is disclosed. The architectural-structure covering comprises a covering movable between an extended position and a retracted position, said covering including a top portion and a bottom portion and a bottom rail coupled to said bottom portion of said covering, said bottom rail including a channel arranged and configured to receive said bottom portion therein, wherein said bottom portion of said covering is arranged and configured to be received within said bottom rail, said bottom portion of said covering positioned along a tortuous pathway within said bottom rail.

In accordance with another separate and distinct aspect, that may or may not be used with the aspects described herein, the bottom rail includes a front profile or surface that substantially corresponds to the front profile, or portion thereof, of a covering such as, for example, when used in combination with a battened roller, the front surface of the bottom rail may correspond to the profile of a slat or batten. In this manner, the front surface of the covering is arranged and configured to provide a consistent profile, which results in improved overall aesthetics.

In one example of an embodiment, an architectural-structure covering is disclosed. The architectural-structure covering comprises a covering movable between an extended position and a retracted position, said covering including a top portion, a bottom portion, and a plurality of horizontally extending battens vertically spaced between said top and bottom portions, each of said plurality of horizontally extending battens including a front profile and a bottom rail coupled to said bottom portion of said covering, said bottom rail including a channel arranged and configured to receive said bottom portion therein, wherein said bottom rail includes a front profile corresponding to said front profile of said plurality of horizontally extending battens.

Moreover, in accordance with another aspect, the bottom rail may be arranged and configured to enclose the lowermost slat or batten coupled to the inner surface of the battened roller. Thus arranged, by encasing the lowermost slat or batten, the bottom rail is able to maintain the consistent spacing of the slats or battens formed in the covering throughout the length of the covering. In addition, when combined with a bottom rail having a front profile corresponding to the front profile of the slats or battens, consistent and improved aesthetics can be provided throughout the length of the covering.

### BRIEF DESCRIPTION OF THE DRAWINGS

FIG. 1 is a front, perspective view illustrating a convenient architectural-structure covering;

FIG. 2 is a front view illustrating an example of an embodiment of a battened roller covering that may be used in an architectural-structure covering;

FIG. 3 is a partial, front, perspective view illustrating the covering shown in FIG. 2;

FIG. 4 is a front, partial, perspective view illustrating an example of an embodiment of a bottom rail in accordance with the present disclosure, the bottom rail being coupled to an illustrative example of an embodiment of a covering of an architectural-structure covering;

FIG. 5 is a rear, side, partial, perspective view illustrating the bottom rail shown in FIG. 4;

FIG. 6 is a cross-sectional view of the bottom rail shown in FIG. 4, taken along line VI-VI in FIG. 4;

FIG. 7 is a front, perspective view of an example of an embodiment of a front or first member of the bottom rail shown in FIG. 4;

FIG. 8 is a side view illustrating the front or first member of the bottom rail shown in FIG. 7;

FIG. 9 is a rear, perspective view of an example of an embodiment of a rear or second member of the bottom rail shown in FIG. 4;

FIG. 10 is a side view illustrating the rear or second member of the bottom rail shown in FIG. 9;

FIG. 11A is a front, side, perspective view of an example of an embodiment of an end cap that may be used with the bottom rail shown in FIG. 4;

FIG. 11B is a rear, side, perspective view illustrating the end cap shown in FIG. 11A;

FIG. 11C is a front view illustrating the end cap shown in FIG. 11A;

FIG. 12A is a front, side, perspective view of an example of an embodiment of an end cap that may be used with the bottom rail shown in FIG. 4;

FIG. 12B is a rear, side, perspective view illustrating the end cap shown in FIG. 12A; and

FIG. 12C is a front view illustrating the end cap shown in FIG. 12A.

### DETAILED DESCRIPTION

Various features, aspects, or the like of a bottom rail for architectural-structure coverings will now be described more fully hereinafter with reference to the accompanying drawings, in which one or more aspects or features of a bottom rail will be shown and described. It should be appreciated that the various features, aspects, or the like may be used independently of, or in combination, with each other. It will be appreciated that a bottom rail as disclosed herein may be embodied in many different forms and should not be construed as being limited to the embodiments set forth herein with all features being present. Rather, these embodiments are provided so that this disclosure will convey certain aspects of a bottom rail to those skilled in the art. In the drawings, like numbers refer to like elements throughout unless otherwise noted.

It should be understood that, as described herein, an “embodiment” (such as illustrated in the accompanying Figures) may refer to an illustrative representation of an environment or article or component in which a disclosed concept or feature may be provided or embodied, or to the representation of a manner in which just the concept or feature may be provided or embodied. However, such illustrated embodiments are to be understood as examples (unless otherwise stated), and other manners of embodying the described concepts or features, such as may be understood by one of ordinary skill in the art upon learning the concepts or features from the present disclosure, are within the scope of the disclosure. In addition, it will be appreciated that while the Figures may show one or more embodiments of concepts or features together in a single embodiment of an environment, article, or component incorporating such concepts or features, such concepts or features are to be understood (unless otherwise specified) as independent of and separate from one another and are shown together for the sake of convenience and without intent to limit to being present or used together. For instance, features illustrated or described as part of one embodiment can be used separately, or with another embodiment to yield a still further embodiment. Thus, it is intended that the present subject matter covers such modifications and variations as come within the scope of the appended claims and their equivalents.

As will be described in greater detail below, a bottom rail in accordance with one or more aspects of the present disclosure may be arranged and configured to be coupled to a covering of an architectural-structure covering so that the covering is properly positioned in the extended position while preventing or minimizing the bottom portion of the covering from having an undesired aesthetic finish (e.g., skewed or generally shaped differently from other portions of the covering). In one example of an embodiment, the covering may be in the form of a battened roller including a plurality of vertically spaced slats or battens extending horizontally across the width of the covering.

In one example of an embodiment, a bottom rail arranged and configured to couple to a bottom portion of a covering in an architectural-structure covering is disclosed. In one example of an embodiment, the bottom rail may be a multi-piece bottom rail including a first or front member, and a second or rear member. The front and rear members are arranged and configured to be coupled to each other with a bottom portion of a covering positioned in between the front and rear members. For example, the bottom rail comprises: a front member; and a rear member arranged and configured to couple to the front member, the front and rear members defining a channel when the rear member is coupled to the front member; wherein: the channel is arranged and configured to receive a portion of the covering therethrough; and the front and rear members are arranged and configured to couple to each other with the bottom portion of the covering extending at least partially with the channel.

In another example of an embodiment, that may or may not be used with a multi-piece bottom rail, the covering is arranged and configured to be received within a bottom rail along a tortuous pathway. For example, an architectural-structure covering comprises: a covering movable between an extended position and a retracted position, the covering including a top portion and a bottom portion; and a bottom rail coupled to the bottom portion of the covering, the bottom rail including a channel arranged and configured to receive the bottom portion therein; wherein the bottom portion of the covering is arranged and configured to be received within the bottom rail, the bottom portion of the covering positioned along a tortuous pathway within the bottom rail.

In another example of an embodiment, an architectural-structure covering is disclosed. The architectural-structure covering comprising: a covering movable between an extended position and a retracted position, the covering including a top portion, a bottom portion, and a plurality of horizontally extending battens vertically spaced between the top and bottom portions, each of the plurality of battens including a front profile; and a bottom rail coupled to the bottom portion of the covering, the bottom rail including a channel arranged and configured to receive the bottom portion therein; wherein the bottom rail includes a front profile substantially corresponding to the front profile of the battens.

In the Figures, for the sake of convenience and clarity, all directional references or terms such as, for example, “face,” “front,” “back,” “rear,” “top,” “bottom,” “up,” “down,” “vertical,” “horizontal”, “inner,” “outer”, “proximal,” “distal,” “upper,” “lower,” “upward,” “downward,” “left”, “right,” “lateral,” “longitudinal,” “above,” “below,” “vertical,” “horizontal,” “radial,” “axial,” “clockwise,” and “counterclockwise” are only used for identification purposes to aid the reader's understanding of the present disclosure, and do not create limitations, particularly as to the position, orientation, or use of this disclosure. These references are used herein to describe the relative placement and orientation of various components and portions of the architectural-structure covering 100 illustrated in the Figures, each with respect to the geometry and orientation of the architectural-structure covering 100 as they appear in the Figures. Said reference is intended to be non-limiting and is used herein merely to describe relationship between various components as illustrated in the Figures.

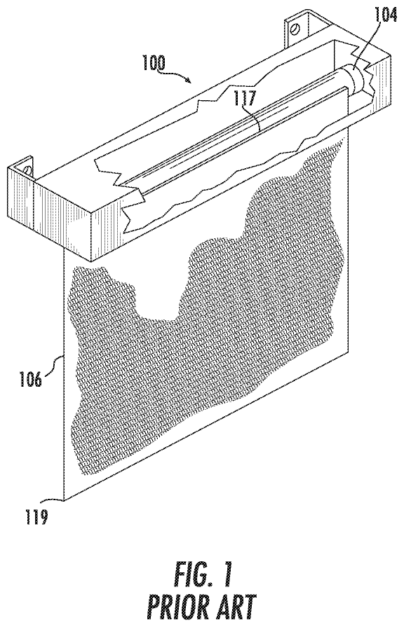

Referring to FIG. 1, a front view of an example of an embodiment of an architectural-structure covering 100 is shown. As shown, the architectural-structure covering 100 includes a covering 106. The architectural-structure covering 100 may be arranged and configured to be mounted to a wall or other structure above an architectural structure in a conventional manner that will be recognized by those of ordinary skill in the art. In use, the covering 106 may be arranged and configured to be vertically extended and retracted between an extended position (shown in FIG. 1), wherein the covering 106 may partially or entirely cover the architectural structure, and a retracted position, wherein the covering 106 may be retracted, and at least the covering 106 is substantially hidden. For example, as shown, the architectural-structure covering 100 may include a rotatable roller tube 104. The covering 106 may include an upper portion or edge 117 coupled to the rotatable roller tube 104 and a bottom edge or portion 119. As will be readily appreciated by one of ordinary skill in the art, the covering 106 of the architectural-structure covering 100 may be suspended from the rotatable roller tube 104 and may be vertically extended and retracted between the extended position (shown in FIG. 1), and the retracted position. Although not shown, an appropriate known or heretofore to be developed drive mechanism can be provided to move the covering 106 between the extended and retracted positions. In addition, the present disclosure is not limited to a particular roll-up direction, and the architecture-structure covering 100 may be arranged and configured to operate in a conventional manner, or in a reverse-roll-up. Although a particular example of an architectural-structure covering 100 is shown in FIG. 1, many different types and styles of architectural-structure coverings exist and can be employed in place of the example illustrated in FIG. 1. As such, it should be understood that features of the present disclosure may be used in combination with any suitable architectural-structure covering now known or hereafter developed and thus features of the present disclosure should not be limited to any particular type of architectural-structure covering. For example, it should be appreciated that the covering 106 may be a flexible material, however any suitable covering now known or hereafter developed is envisioned.

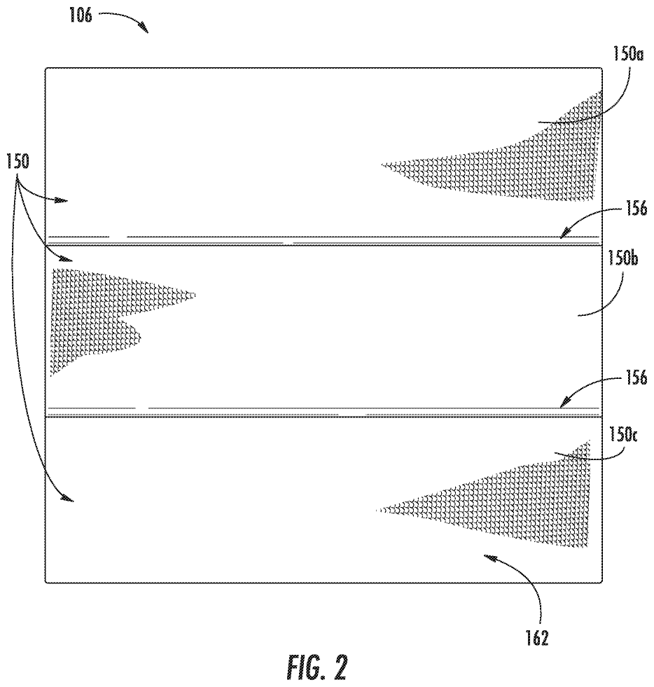

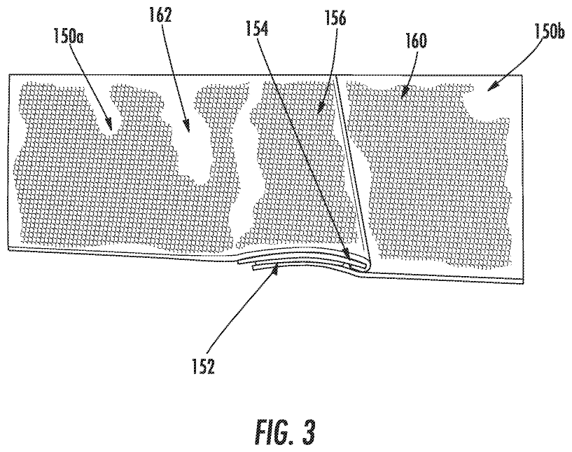

For example, referring to FIGS. 2 and 3, one example of an embodiment of a covering 106 that may be used in connection with an architectural-structure covering is a battened roller. Generally speaking, a non-limiting example of an embodiment of the covering 106 may be manufactured from a flexible, fabric material including, for example, a plurality of slats or battens (e.g., substantially rigid elements), vertically spaced along a length of the covering. In use, the slats or battens may stiffen the covering to prevent or substantially prevent the covering from wrinkling when extended. Additional details are disclosed and illustrated in U.S. patent application Ser. No. 15/510,181, filed Mar. 9, 2017, entitled Roll-Up Coverings for Architectural Openings and Related Methods, Systems and Devices, and U.S. patent application Ser. No. 14/899,216, filed Dec. 17, 2015, entitled Coverings for an Architectural Opening Having Coved Slats, the entire contents of which applications are hereby incorporated by reference. Alternatively, another example of a battened roller is disclosed and illustrated in U.S. patent application Ser. No. 15/947,954, filed on Apr. 9, 2018 entitled “Battened Roller Covering”, the entire contents of which are hereby incorporated by reference, although it should be understood that a bottom rail of the present disclosure can be used with any covering now known or hereafter developed.

As illustrated in FIGS. 2 and 3, a non-limiting example of an embodiment of the covering 106 may be manufactured from a plurality of joined assembled strips of fabric material (hereinafter “assembled strips”) 150 for example, first, second, and third assembled strips 150a, 150b, 150c. Each assembled strip 150 includes a first slat 152 and a second slat 154 (FIG. 3) on either side of an intermediate piece of material 160. For example, the intermediate piece of material 160 may include an inner surface (e.g., room facing) 162 and an outer surface (e.g., window or wall facing). The first slat 152 may be coupled to the intermediate piece of material 160 adjacent to a top end thereof while the second slat 154 may be coupled to the intermediate piece of material 160 adjacent to a bottom end. The first slat 152 may be coupled to the inner surface (e.g., room facing) 162, while the second slat 154 may be coupled to the outer surface (e.g., window or wall facing). As such, the first and second slats 152, 154 are coupled to the intermediate piece of material 160 on opposite inner and outer surfaces thereof, respectively. In use, the first and second slats 152, 154 may stiffen the intermediate piece of material 160 to prevent or substantially prevent the intermediate piece of material 160 from wrinkling when the intermediate piece of material 160 is extended from the rotatable roller tube 104. Thereafter, the first slat 152 of a first assembled strip 150a may be coupled to the second slat 154 of a second, adjoining assembled strip 150b via, for example, an adhesive.

Once assembled, the coupled first and second slats 152, 154 of adjoining assembled strips 150 provide the covering 106 with an outward appearance of a plurality of vertically spaced slats or battens extending horizontally across the width of the covering 106.

A bottom rail may be coupled to a bottom edge or portion 119 of the covering 106, for example, a bottom portion of a lowermost assembled strip. However, incorporation of a bottom rail may result in undesirable aesthetic impacts on the appearance of the covering 106. For example, it has been found aesthetically desirable to maintain a consistent appearance throughout the covering (e.g., from a top end of the covering to a bottom end of the covering). However, adding a bottom rail to a bottom portion of the covering can alter the appearance of the covering, particularly adjacent to the bottom portion of the covering. For example, when utilized with a battened roller, the additional of a bottom rail may alter the height of the lowermost assembled strip thus changing the overall appearance of the covering (e.g., may alter the consistent vertical spacing between battens extending across the width of the covering). In addition, when coupling a bottom rail to a bottom portion of a covering, the bottom rail may skew or rotate the covering thereby preventing the covering from hanging straight, which may adversely affect the aesthetics of the covering.

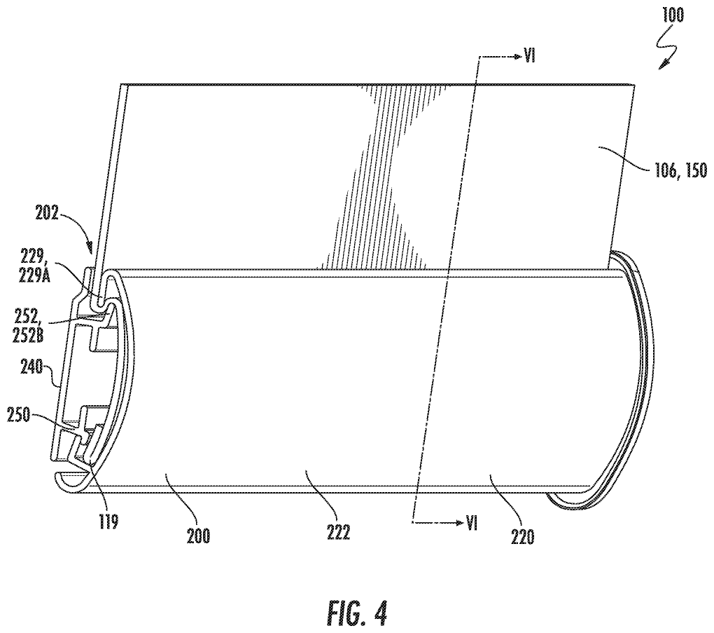

Referring now to FIGS. 4-6, in accordance with one separate and distinct aspect of the present disclosure that may be used separately from, or in combination with, other aspects of a bottom rail disclosed herein (e.g., the separate and distinct aspect may be used in combination with a bottom rail having one or more of the features described herein, or may be used with a conventional bottom rail not having all or some of the features disclosed herein), a non-limiting example of an embodiment of a multi-piece bottom rail 200 will now be described. As shown, the bottom rail 200 includes a first or front member 220 and a second or rear member 240 (first or front, and second or rear, used interchangeably herein without the intent to limit), although it is envisioned that the bottom rail 200 may include more members.

In use, the first member 220 and the second member 240 are arranged and configured to be coupled to each other. As illustrated, the first member 220 is arranged and configured to be coupled with the second member 240 with a bottom portion of a covering such as, for example, the bottom edge or portion 119 of covering 106, a bottom portion of the lowermost assembled strip 150, etc. positioned in between the first and second members 220, 240. Thus arranged, the first member 220 is coupled, clamped, secured, attached, etc. (used interchangeably herein without the intent to limit) to the second member 240, and the bottom rail 200 is securely coupled to the covering.

The first member 220 may be coupled to the second member 240 by any suitable mechanism now known or hereafter developed. As will be described in greater detail below, in one example of an embodiment, the first member 220 is arranged and configured to be coupled to the second member 240 via interlocking legs, projections, or other physical features (e.g., the second member 240 is arranged and configured to snap-fitted together with the first member 220 to facilitate easier assembly). That is, as will be described in greater detail, in one example of an embodiment, a leg extending from the second member 240 may be placed into engagement with the first member 220, or may be snapped in, such as by inserting one edge of the second member 240 behind an inwardly directed corresponding edge of the first member 220, and then snapping another edge of the second member 240 behind an inwardly directed corresponding edge of the first member 220. In various examples of embodiments, the first and second members 220, 240 are arranged and configured to be coupled to each other without any additional coupling elements (e.g., the second member 240 may be coupled to the first member 220 without any additional fasteners, adhesive, etc.).

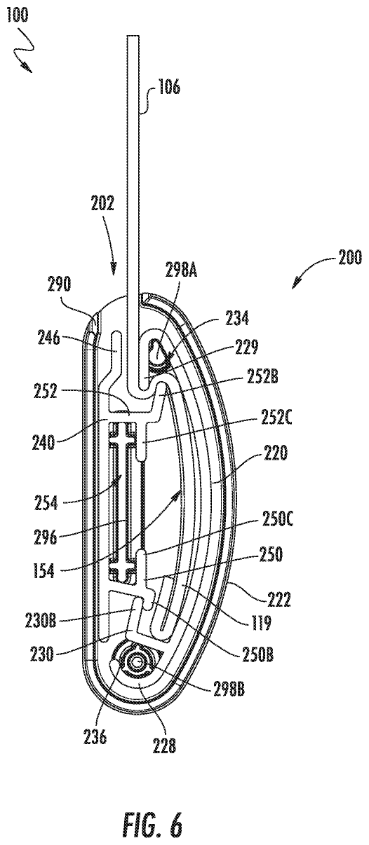

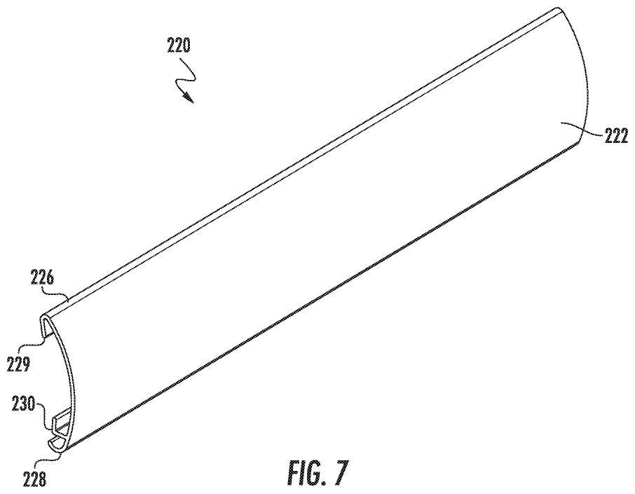

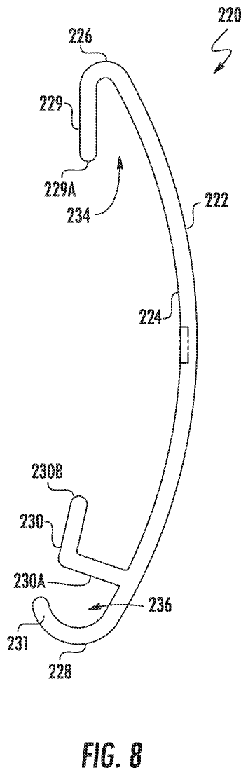

Referring to FIGS. 7 and 8, in one non-limiting example of an embodiment, the first member 220 includes a front surface 222, a rear surface 224, a top edge portion 226, and a bottom edge portion 228. In the illustrated example of the embodiment, the first member 220 may also include a downwardly extending leg, projection, etc. 229 (used interchangeably herein without the intent to limit). The first member 220 may also include an upwardly extending leg 231. As shown, in one example of an embodiment, the downwardly extending leg may extend from the top edge portion 226 and the upwardly extending leg 231 may extend from the bottom edge portion 228. The first member 220 may also include a first leg 230 extending from the first member 220 and towards the second member 240 when the first and second members 220, 240 are coupled to each other (e.g., the first leg 230 may extend from the rear surface 224). As shown, the first leg 230 may be positioned adjacent to, or in close proximity to, the bottom edge portion 228 of the first member 220. In one example of an embodiment, the first leg 230 may include a first leg portion 230A extending from the first member 220 and towards the second member 240 when the first and second members 220, 240 are coupled to each other and a second leg portion 230B extending at an angle with respect to the first leg portion 230A. As shown, the second leg portion 230B may extend upwards at an angle relative to the first leg portion 230A. As will be described in greater detail below, the downwardly extending leg 229 and the rear surface 224 of the first member 220 define a first channel 234. Similarly, the upwardly extending leg 231 and the first leg 230 may define a second channel 236. As will be described in greater detail below, the first and second channels 234, 236 are arranged and configured to receive retention members formed on lateral end caps for coupling the lateral end caps to the ends of the bottom rail (FIG. 6). As shown, the first member 220 including the top edge portion 226, the bottom edge portion 228, the downwardly extending leg 229, the upwardly extending leg 231, and the first leg 230 may be integrally formed. Alternatively, they may be separately formed and coupled to one another. Although an example of an embodiment of a first member 220 is shown and described, it should be understood that the first member 220 may be provided in alternate configurations including any number, arrangement, and configuration of legs.

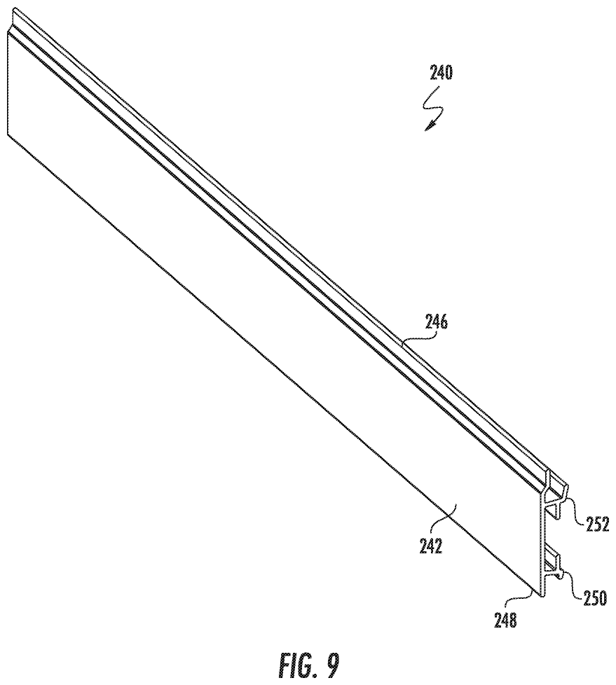

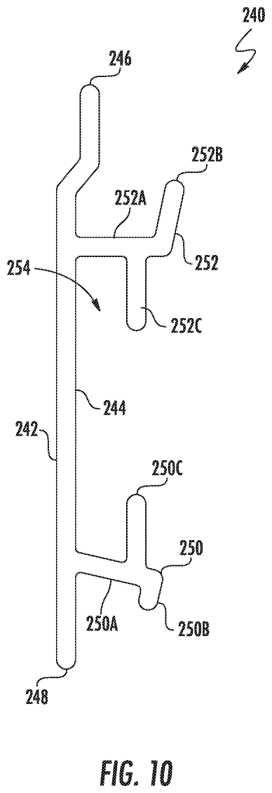

Referring to FIGS. 9 and 10, in one example of an embodiment, the second member 240 includes a rear surface 242, a front surface 244, a top edge portion 246, and a bottom edge portion 248. In the illustrated example of the embodiment, the second member 240 may also include a first leg 250 extending from the second member 240 and towards the first member 220 when the first and second members 220, 240 are coupled to each other (e.g., the first leg 250 may extend from the front surface 244). In one example of an embodiment, the first leg 250 may include a first leg portion 250A extending from the second member 240 and towards the first member 220 when the first and second members 220, 240 are coupled to each other and a second leg portion 250B extending at an angle with respect to the first leg portion 250A. As shown, the second leg portion 250B may extend downwards at an angle relative to the first leg portion 250A. In addition, the first leg 250 may include a third leg portion 250C extending upwardly at an angle with respect to the first leg portion 250A. In the illustrated example of the embodiment, the second member 240 may also include a second leg 252 extending from the second member 240 and towards the first member 220 when the first and second members 220, 240 are coupled to each other. In one example of an embodiment, the second leg 252 may include a first leg portion 252A extending from the second member 240 and towards the first member 220 when the first and second members 220, 240 are coupled to each other and a second leg portion 252B extending at an angle with respect to the first leg portion 252A. As shown, the second leg portion 252B may extend upwards relative to the first leg portion 252A. In addition, the second leg 252 may include a third leg portion 252C extending downwards at an angle with respect to the first leg portion 252A. As will be described in greater detail below, the upwardly extending third leg portion 250C formed on the first leg 250 and the downwardly extending third leg portion 252C formed on the second leg 252 define a channel 254. As will be described in greater detail below, the channel 254 is arranged and configured to receive a retention member formed on lateral end caps for coupling the lateral end caps to the bottom rail (FIG. 6). As shown, the second member 240 including the top edge portion 246, the bottom edge portion 248, the first leg 250, and the second leg 252 may be integrally formed. Alternatively, they may be separately formed and coupled to one another. Although an example of an embodiment of a second member 240 is shown and described, it should be understood that the second member 240 may be provided in alternate configurations including any number, arrangement, and configuration of legs.

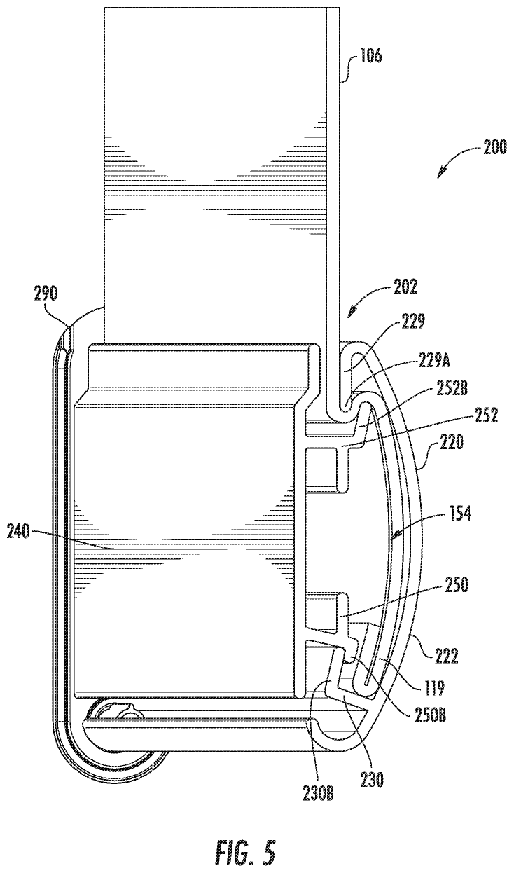

In use, and as best shown in FIGS. 5 and 6, the first leg 250 formed on the second member 240 is arranged and configured to interact, couple, or the like, with the first leg 230 formed on the first member 220. More specifically, the second leg portion 230B of the first leg 230 formed on the first member 220 is arranged and configured to receive the second leg portion 250B of the first leg 250 formed on the second member 240. Thereafter, with the bottom edge or portion 119 of the covering 106 positioned between the first and second members 220, 240, the first and second members 220, 240 can be moved or pivoted with respect to each other until the covering 106 is sandwiched between the first and second members 220, 240. More specifically, with the bottom edge or portion 119 of the covering 106 positioned between the first and second members 220, 240, the first and second members 220, 240 can be moved or pivoted with respect to each other until the downwardly extending leg 229 formed on the first member 220 is received by the upwardly extending second leg portion 252B of the second leg 252 formed on the second member 240.

Furthermore, as will be described in greater detail below in connection with another separate and distinct aspect that may be combined with the multi-piece bottom rail, the second leg 252 extending from the second member 240 may wind, bend, etc. the bottom portion of the covering 106 so that the bottom portion of the covering 106 bends around a lower end portion 229A of the downwardly extending leg 229, and then upwards over the second leg portion 252B of the second leg 252 extending from the second member 240. Thus arranged, a portion of the bottom portion of the covering 106 is positioned between the lower end portion 229A of the downwardly extending leg 229, and the second leg portion 252B of the second leg 252 extending from the second member 240.

In this manner, the interlocking legs formed on the first and second member 220, 240 act to couple the first and second members 220, 240 to each other, to form a tortuous pathway for the bottom portion of the covering 106, and to fixedly couple the bottom portion of the covering 106 to the bottom rail 200.

Referring now to FIGS. 4-6, in accordance with another separate and distinct aspect of the present disclosure that may be used separately from, or in combination with, other aspects of a bottom rail disclosed herein (e.g., the separate and distinct aspect may be used in combination with a bottom rail having one or more of the features described herein, or may be used with a conventional bottom rail not having all or some of the features disclosed herein), one non-limiting example of an embodiment of a bottom portion of a covering such as, for example, the bottom edge or portion 119 of covering 106, a bottom portion of the lowermost assembled strip 150, etc. is arranged and configured to be received within the bottom rail 200. Thereafter, the bottom portion of the covering is captured within, positioned within, positioned along, or the like (used interchangeably without the intent to limit) a tortuous pathway therein. By coupling the covering 106 to the bottom rail 200 via a tortuous (e.g., twisting, winding, curving, bending, or the like) pathway, two advantages are achieved. First, the covering 106 is firmly secured to the bottom rail 200, thus preventing, or at least reducing, the likelihood that the bottom rail 200 may be become decoupled from the covering 106 during use. Second, the tortuous pathway of the covering 106 skews (e.g., rotates) the bottom rail 200 such that the bottom rail 200 lies in a substantially vertically oriented position, thus improving the overall aesthetics of the covering. That is, the tortuous pathway of the covering 106 may be arranged and configured to skew the bottom rail into an upright position.

Referring to FIGS. 4-6, when used in combination with a multiple piece bottom rail such as, for example, bottom rail 200, the covering 106 may be received within the bottom rail 200 through a top opening channel or spacing 202 defined by the downwardly extending leg 229 of the first member 220 and the top edge portion 246 of the second member 240. Thereafter, the interior profiles of the first and second members 220, 240 of the bottom rail 200 are arranged and configured to provide a tortuous pathway for the covering 106 (e.g., the covering 106 does not extend in a linear pathway within the bottom rail 200), which tends to lock the covering 106 in place between the first and second members 220, 240. For example, as shown, in one example of an embodiment, the covering 106 may bend such as, for example, around a lower end portion 229A of the downwardly extending leg 229, and then upwards over the second leg portion 252B of the second leg 252 extending from the second member 240.

Providing a tortuous pathway for the covering 106 allows the covering 106 to impart balanced rotational forces to the assembled bottom rail 200 so that the bottom rail 200, when assembled with the covering 106, is appropriately vertically positioned. That is, by bending the pathway of the covering 106 within the bottom rail 200, rotational forces are applied by the covering 106 to the bottom rail 200, which when properly balanced, cause the bottom rail 200 to lie in a substantially vertically oriented position, aligned with the covering 106.

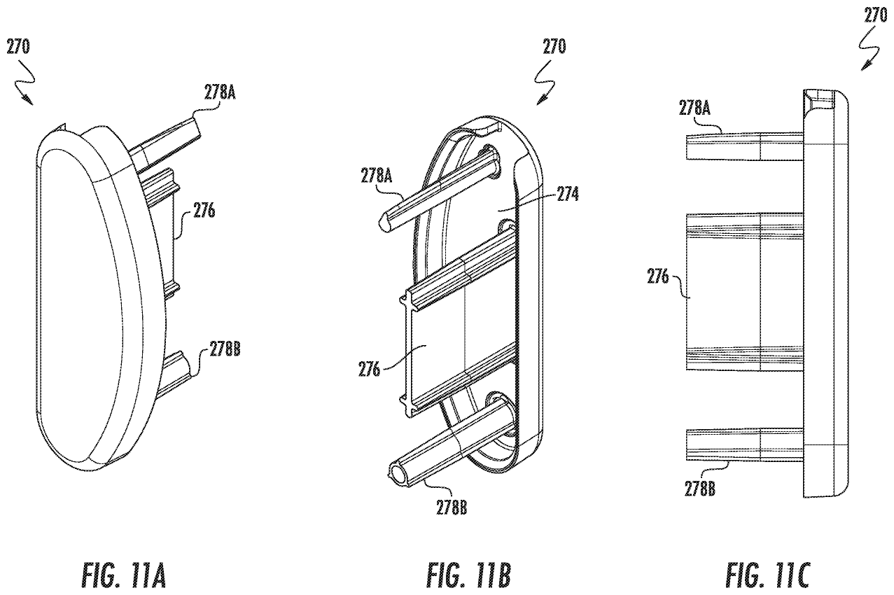

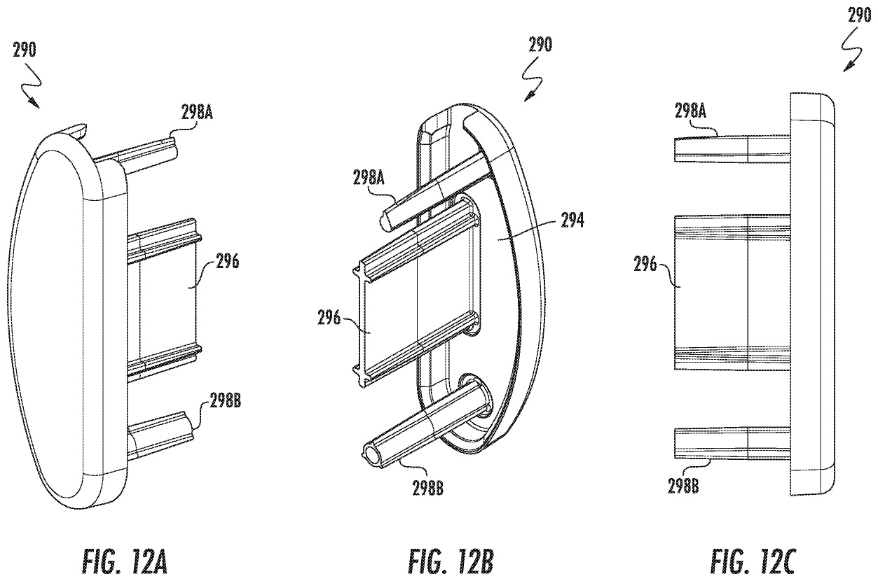

Thereafter, referring to FIGS. 11A-12C, the bottom rail 200 may also include first and second lateral end caps 270, 290 for coupling to either end of the bottom rail 200. That is, the first and second lateral end caps 270, 290 may be disposed on opposing longitudinal ends of the bottom rail 200 (e.g., first and second lateral end caps 270, 290 are arranged and configured to couple to respective ends of the bottom rail 200). The first and second lateral end caps 270, 290 may be coupled to the ends of the bottom rail 200 using any now known or hereafter developed mechanism. For example, the first and second lateral end caps 270, 290 may include respective retention members 276, 296 extending from respective inner surfaces 274, 294 thereof. The retention members 276, 296 may be arranged and configured to be inserted into the channel 254 formed in the second member 240 defined by the downwardly extending third leg portion 252C of the second leg 252 and the upwardly extending third leg portion 250C of the first leg 250 (FIG. 6). In addition, the first and second lateral end caps 270, 290 may include respective retention members 278, 298 extending from respective inner surfaces 274, 294 thereof. As shown, the first and second lateral end caps 270, 290 may include respective first and second retention members 278A, 278B, 298A, 298B. The retention members 278, 298 may be arranged and configured to be inserted into the first and second channels 234, 236 formed in the first member 220 (FIG. 6). Thus arranged, the first and second lateral end caps 270, 290 are arranged and configured to couple to each of the first and second members 220, 240 thus assisting with securely coupling the first and second members 220, 240 to each other. The examples of the various embodiments of the present disclosure are not limited in this regard, and it is contemplated that the first and second lateral end caps 270, 290 may be coupled to the bottom rail 200 in any conventional manner known in the art.

Referring now to FIGS. 4, and 6-8, in accordance with another separate and distinct aspect of the present disclosure that may be used separately from, or in combination with, other aspects of a bottom rail disclosed herein (e.g., the separate and distinct aspect may be used in combination with a bottom rail having one or more of the features described herein, or may be used with a conventional bottom rail not having all or some of the features disclosed herein), a non-limiting example of an embodiment of a bottom rail such as, for example, bottom rail 200 includes a front profile or surface 222 that substantially corresponds to the front profile, or portion of the front profile, of a covering with features such as, battens or other evenly spaced horizontally extending members, such as, for example, when used in combination with a battened roller shade as illustrated in FIGS. 2 and 3, the front profile or surface 222 of the bottom rail 200 may substantially correspond to the front profile or surface of the battens 156 formed by the first and second slats 152, 154. In this manner, the front surface of the covering 106 is arranged and configured to provide a consistent profile (e.g., a uniform appearance across the front surface of the covering 106 is provided), which results in improved overall aesthetics.

That is, in accordance with one aspect of the present disclosure, when used in combination with a battened roller shade as generally illustrated in FIGS. 2 and 3, the front surface of the bottom rail such as, for example, the front surface 222 of the first member 220 of the bottom rail 200 may include a front profile that substantially corresponds to the profile of the batten 156 defined by the second slat 154 coupled to the inner surface of the lowermost assembled strip 150.

Moreover, in accordance with another separate and distinct aspect of the present disclosure that may be used separately from, or in combination with, other aspects of a bottom rail disclosed herein (e.g., the separate and distinct aspect may be used in combination with a bottom rail having one or more of the features described herein, or may be used with a conventional bottom rail not having all or some of the features disclosed herein), one non-limiting example of an embodiment of a bottom rail such as, for example, the bottom rail 200 may be arranged and configured to enclose the lowermost, second slat 154 coupled to the inner surface of the lowermost assembled strip 150. Thus arranged, by encasing the lowermost, second slat 154, the bottom rail 200 is able to maintain the consistent spacing of the slats or battens formed in the covering 106 throughout the length of the covering 106. In addition, when combined with a bottom rail having a front profile corresponding to the front profile of the slats or battens, consistent and improved aesthetics are achieved.

In this manner, the bottom rail 200 (e.g., front surface 222) is arranged and configured to complement the profile (e.g., curvature) of the slats or batten on a battened roller so that the batten or slat of the lowermost assembled strip of the covering can be inserted into the concave area formed in the bottom rail. In use, the batten or slat is captured between the first and second members 220, 240 of the bottom rail 200.

That is, for example, in one example of an embodiment, the first member 220 may be arranged and configured with a shape substantially corresponding to the shape or front profile of a horizontally extending slat or batten formed on a front surface of the covering. Thereafter, the lowermost slat or batten may be positioned adjacent to the rear surface 224 of the first member 220. Next, with the lowermost slat or batten positioned adjacent to the rear surface 224 of the first member 220, the second member 240 may enclose the lowermost batten formed on the front surface of the covering and be coupled to the first member 220. In this manner, the lowermost slat or batten may be enclosed by the bottom rail and the bottom rail may provide a front profile or surface 222 that substantially corresponds and takes the place of the lowermost batten thus providing a consistent profile, which results in improved overall aesthetics.

In addition, the bottom rail 200 (e.g., at least the front surface 222 of the bottom rail 200) may be covered with a face fabric corresponding to the fabric of the covering. As such, the appearance of the bottom rail complements the appearance of the battens of the battened roller, imparting a desired aesthetic, uniform appearance over the entire length of the covering. In use, the face fabric may be wrap around to the rear surface 224, or at least a portion thereof, of the first member 220. Thus arranged, when the second member 240 is coupled to the first member 220, the face fabric may be clamped between the first and second members 220, 240 of the bottom rail 200. As such, the face fabric is securely coupled to the bottom rail obviating issues with conventional face fabrics separating from the underlying rail.

While the present disclosure refers to certain embodiments, numerous modifications, alterations, and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

The foregoing description has broad application. It should be appreciated that the concepts disclosed herein may apply to many types of coverings, in addition to the coverings described and depicted herein. The discussion of any embodiment is meant only to be explanatory and is not intended to suggest that the scope of the disclosure, including the claims, is limited to these embodiments. In other words, while illustrative embodiments of the disclosure have been described in detail herein, it is to be understood that the inventive concepts may be otherwise variously embodied and employed, and that the appended claims are intended to be construed to include such variations, except as limited by the prior art.

As used herein, an element or step recited in the singular and proceeded with the word “a” or “an” should be understood as not excluding plural elements or steps, unless such exclusion is explicitly recited.

The phrases “at least one”, “one or more”, and “and/or”, as used herein, are open-ended expressions that are both conjunctive and disjunctive in operation. The terms “a” (or “an”), “one or more” and “at least one” can be used interchangeably herein. Connection references (e.g., engaged, attached, coupled, connected, and joined) are to be construed broadly and may include intermediate members between a collection of elements and relative to movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another. The drawings are for purposes of illustration only and the dimensions, positions, order and relative to sizes reflected in the drawings attached hereto may vary.

The foregoing discussion has been presented for purposes of illustration and description and is not intended to limit the disclosure to the form or forms disclosed herein. For example, various features of the disclosure are grouped together in one or more aspects, embodiments, or configurations for the purpose of streamlining the disclosure. However, it should be understood that various features of the certain aspects, embodiments, or configurations of the disclosure may be combined in alternate aspects, embodiments, or configurations. Moreover, the following claims are hereby incorporated into this Detailed Description by this reference, with each claim standing on its own as a separate embodiment of the present disclosure.

1. A bottom rail arranged and configured to couple to a bottom portion of a covering in an architectural-structure covering, the bottom rail comprising:
a front member; and
a rear member arranged and configured to couple to said front member, said front and rear members defining a channel when said rear member is coupled to said front member;
wherein:
said channel is arranged and configured to receive a portion of the covering therethrough; and
said front and rear members are arranged and configured to couple to each other with the bottom portion of the covering extending at least partially with said channel.

2. The bottom rail of claim 1, wherein said front member and rear member each include interlocking legs arranged and configured to couple said front member to said rear member.

3. The bottom rail of claim 1, wherein said front member and said rear member are arranged and configured to be snap-fitted together.

4. The bottom rail of claim 1, wherein said front member and said rear member are arranged and configured to be coupled to each other without any additional coupling elements.

5. The bottom rail of claim 1, wherein said front member includes a front surface, a rear surface, a top edge portion, a bottom edge portion, a downwardly extending leg, and a first leg extending from said front member towards said rear member when coupled together.

6. The bottom rail of claim 5, wherein said rear member includes a rear surface, a front surface, a top edge portion, a bottom edge portion, a first leg extending from said rear member towards said front member when coupled together, and a second leg extending from said rear member towards said front member when coupled together.

7. The bottom rail of claim 6, wherein said first leg formed on said rear member is arranged and configured to couple with said first leg formed on said front member.

8. The bottom rail of claim 6, wherein said first leg of said front member includes a first leg portion extending from said front member towards said rear member when coupled together and a second leg portion extending at an angle with respect to said first leg portion of said first leg of said front member.

9. The bottom rail of claim 8, wherein said first leg of said rear member includes a first leg portion extending from said rear member towards said front member when coupled together and a second leg portion extending at an angle with respect to said first leg portion of said first leg of said rear member.

10. The bottom rail of claim 9, wherein said second leg of said rear member includes a first leg portion extending from said rear member towards said front member when coupled together and a second leg portion extending at an angle with respect to said first leg portion of said second leg of said rear member.

11. The bottom rail of claim 10, wherein said second leg portion of said first leg of said front member is arranged and configured to receive said second leg portion of said first leg of said rear member.

12. The bottom rail of claim 10, wherein said downwardly extending leg formed on said front member is received by said second leg portion of said second leg of said rear member.

13. The bottom rail of claim 1, further comprising first and second lateral end caps arranged and configured to couple to respective ends of said bottom rail, each of said first and second lateral end caps including a first retention member arranged and configured to couple to a channel formed in said rear member, and one or more retention members arranged and configured to couple to one or more respective channels formed in said front member.

14. The bottom rail of claim 1, wherein the bottom portion of the covering is arranged and configured to be received within said channel of said bottom rail and then positioned along a tortuous pathway therein.

15. The bottom rail of claim 14, wherein said front and rear members include one or more legs arranged and configured to provide said tortuous pathway.

16. The bottom rail of claim 15, wherein the bottom portion of the covering is arranged and configured to bend around a lower end portion of a downwardly extending leg formed on said front member, and then bend over a first leg portion of an upwardly extending leg extending from said rear member.

17. The bottom rail of claim 1, wherein said bottom rail includes a front profile corresponding to a front profile of a horizontally extending batten formed on a front surface of the covering.

18. The bottom rail of claim 17, wherein said bottom rail is arranged and configured to enclose a lowermost batten formed on said front surface of the covering.

19. The bottom rail of claim 1, wherein said front member is arranged and configured to correspond to a front profile of a horizontally extending batten formed on a front surface of the covering.

20. The bottom rail of claim 19, wherein said rear member is arranged and configured to enclose a lowermost batten formed on said front surface of the covering and to coupled to said front member.

21. The bottom rail of claim 1, wherein said bottom rail is arranged and configured to enclose a rigid element coupled to the bottom portion of the covering.

22. An architectural-structure covering comprising:
a covering movable between an extended position and a retracted position, said covering including a top portion and a bottom portion; and
a bottom rail coupled to said bottom portion of said covering, said bottom rail including a channel arranged and configured to receive said bottom portion therein;
wherein said bottom portion of said covering is arranged and configured to be received within said bottom rail, said bottom portion of said covering positioned along a tortuous pathway within said bottom rail.

23. The architectural-structure covering of claim 22, wherein said tortuous pathway skews said bottom rail such that said bottom rail lies in a vertically oriented position when said covering is coupled to said bottom rail.

24. The architectural-structure covering of claim 22, wherein said bottom rail includes one or more legs arranged and configured to provide said tortuous pathway.

25. The architectural-structure covering of claim 22, wherein said bottom portion of said covering is arranged and configured to bend around a lower end portion of a downwardly extending leg, and then bend over a first leg portion of an upwardly extending leg.

26. An architectural-structure covering comprising:
a covering movable between an extended position and a retracted position, said covering including a top portion, a bottom portion, and a plurality of horizontally extending battens vertically spaced between said top and bottom portions, each of said plurality of horizontally extending battens including a front profile; and
a bottom rail coupled to said bottom portion of said covering, said bottom rail including a channel arranged and configured to receive said bottom portion therein;
wherein said bottom rail includes a front profile corresponding to said front profile of said plurality of horizontally extending battens.

27. The architectural-structure covering of claim 26, wherein said bottom rail is arranged and configured to receive a lowermost batten of said plurality of horizontally extending battens.

28. The architectural-structure covering of claim 26, further comprising a fabric coupled to a front surface of said bottom rail, said fabric corresponding to said covering.
